(19) United States
(12) Patent Application Publication
(10) Pub. No.: US 2013/0041995 A1
(43) Pub. Date: Feb. 14, 2013

(54) Method and System for Managing Service Group

(71) Applicants: Lizhe Yao, Shenzhen (CN); Man Xie, Shenzhen (CN); Jun Chen, Shenzhen (CN)

(72) Inventors: Lizhe Yao, Shenzhen (CN); Man Xie, Shenzhen (CN); Jun Chen, Shenzhen (CN)

(73) Assignee: ZTE CORPORATION, Shenzhen, Guangdong (CN)

(21) Appl. No.: 13/583,011

(22) PCT Filed: Feb. 25, 2011
(86) PCT No.: PCT/CN11/71335

§ 371 Date: Sep. 6, 2012

(30) Foreign Application Priority Data
Apr. 30, 2010 (CN) 201010165340.1

(51) Int. Cl. G06F 15/173

(52) U.S. Cl. 709/223

(57) ABSTRACT

The disclosure discloses a method for managing a service group, which comprises: managing the service group by establishing the service group and an information table thereof and updating the service group and the information table thereof. The disclosure also discloses a system for managing a service group, which comprises: a management unit configured to manage a service group by establishing the service group and the information table thereof and updating the service group and the information table thereof. A service group can be managed conveniently and effectively by using the method and system provided in the disclosure.

### TECHNICAL FIELD

The disclosure relates to a service group management technology, and particularly to a method and system for managing a service group in a personal network.

### BACKGROUND

With the development of technology, people own more and more personal devices such as handset, notebook, PDA, MP3 and MP4, which are produced with more and more functions. For instance, most of the personal devices have a short-distance communication capability, therefore, it is desired that the personal devices can be connected together to form a Personal Network (PN) to share resources and capabilities.

FIG. 1 is a schematic diagram illustrating a construction of a network between the devices in a PN, as shown in FIG. 1, the PN includes PN devices, a PN gateway and a PN server, which are in the following network construction relationship: PN 1 consists of PN gateway 1, PN device 1 and PN device 2; PN 2 consists of PN gateway 2, PN device 2 and PN device 3; PN 3 consists of PN gateway 3, PN device 3 and PN device 4; and PN 4 consists of PN gateway 4, PN device 5 and PN device 6. Each PN is connected with the PN server via the PN gateway thereof, and the PN server is connected with a service/content server. In FIG. 1, PN gateway 1 and PN gateway 2 are adjacent to each other, PN gateway 2 and PN gateway 3 are adjacent to each other; PN device 2 belongs to both the PN 1 and the PN 2, and PN device 3 belongs to both PN 2 and PN 3.

However, with the number of PN devices in a PN continuously increasing, how to manage the service group consisting of the PN devices effectively becomes an urgent problem to be solved, and no effective solution to this problem has been provided.

### SUMMARY

In view of this problem, the main object of the disclosure is to provide a method and system for managing a service group to realize a convenient and effective management of the service group.

In order to achieve the purpose above, the technical scheme of the disclosure is realized as follows:

a method for managing a service group includes: the service group is managed by establishing the service group and an information table thereof and the service group and the information table thereof are updated.

In the method, the information table may be an information table for managing the service group, the information table may include at least one of: a name of the service group, an identifier of the service group, strategy information, member information and service type information.

In the method, establishing the service group may include: a personal network (PN) server establishes the service group directly according to a request for establishing the service group, and an invitation is sent to each invited PN device when there are invited PN devices that are invited to join the service group, wherein when establishing the service group, the method may further include: the information table is established for the service group.

In the method, establishing the service group may include: the PN server determines that the service group can be established successfully according to a response of each invited PN device to the request for establishing the service group and related information of the service group, and the service group is established; wherein when establishing the service group, the method may further include: the information table is established for the service group;

when updating the service group, the method may further include: the service group is deleted, a PN device is added to the service group, a PN device is enabled to leave the service group and the information table is updated; wherein when deleting the service group, the PN device is added to the service group and the PN device is enabled to leave the service group, a caused update of the related information of the service group is achieved by updating the established information table, wherein

the deleting the service group includes: the PN server determines that the service group can be deleted successfully according to a response of each PN device to a request for deleting the service group, and deletes the service group;

wherein adding the PN device to the service group includes: the PN server receives a request of the PN device for joining the service group, it is determined that joining the service group is allowed, and then the PN device is added to the service group, and the related information of the service group is updated;

wherein enabling the PN device to leave the service group includes: the PN server receives a request for enabling the PN device to leave the service group, deletes the PN device from the service group and updates the related information of the service group.

In the method, when a PN gateway is triggered to initiate the request for establishing the service group, the method may further include:

the PN gateway sends the request for establishing the service group and the related information of the service group to the PN server; the PN server sends the request for establishing the service group and the related information of the service group to each PN device corresponding to a member in the service group; and the PN server establishes the service group when the PN server determines that the service group can be established successfully according to the response returned from each PN device; or

when the PN device is triggered to initiate the request for establishing the service group, the method may further include:

the PN device sends the request for establishing the service group and the related information of the service group to the PN gateway to which the PN device belongs; the PN gateway sends the request for establishing the service group and the related information of the service group to the PN server; the PN server sends the request for establishing the service group and the related information of the service group to each PN device corresponding to a member in the service group; and the PN server establishes the service group when the PN server determines that the service group can be established successfully according to the response returned from each PN device; or

when the PN server is triggered to initiate the request for establishing the service group, the method may further include:

the PN server sends the request for establishing the service group and the related information of the service group to each PN device corresponding to a member in the service group, and establishes the service group when the PN server determines that the service group can be established successfully according to the response returned from each PN device.

In the method, when the PN gateway or the PN device is triggered to send the request for establishing the service group and the related information of the service group, the method may further include: sending the related information of the service group by including it in the request for establishing the service group or sending the related information of the service group and the request for establishing the service group separately.

In the method, when a PN gateway is triggered to initiate the request for deleting the service group, the method may further include:

the PN gateway sends the request for deleting the service group to the PN server; the PN server sends the request for deleting the service group to each PN device corresponding to a member in the service group; and the PN server deletes the service group when the PN server determines that the service group can be deleted successfully according to the response returned from each PN device; or when the PN device is triggered to initiate the request for deleting the service group, the method may further include:

the PN device sends the request for deleting the service group to the PN gateway to which the PN device belongs; the PN gateway sends the request for deleting the service group to the PN server; the PN server sends the request for deleting the service group to each PN device corresponding to a member in the service group; and the PN server deletes the service group when the PN server determines that the service group can be deleted successfully according to the response returned from each PN device; or

when the PN server is triggered to initiate the request for deleting the service group, the method may further include:

the PN server sends the request for deleting the service group to each PN device corresponding to a member in the service group, and deletes the service group when the PN server determines that the service group can be deleted successfully according to the response returned from each PN device.

In the method, when the PN gateway or the PN device is triggered, and before the request for deleting the service group is sent, the method may further include: requesting the related information of the service group from the PN server;

when the PN gateway or the PN device is triggered, the method may further include, when sending the request for deleting the service group, carrying an identifier of the service group to be deleted in the request for deleting the service group.

when a PN device initiates a request for joining the service group initiatively, the method may further include:

the PN device sends the request for joining the service group to a PN gateway to which the PN device belongs; the PN gateway sends the request for joining the service group to the PN server; the PN server adds the PN device to the service group when the PN server determines that joining the service group is allowed and updates the related information of the service group, and then sends the updated related information of the service group to each PN device corresponding to a member in the service group; or

when a PN device is invited by another PN device to join the service group by initiating a request for inviting the PN device to join the service group, the method may further include:

the another PN device sends the request for inviting the PN device to join the service group to the PN gateway to which the another PN device belongs; the PN gateway sends the request for inviting the PN device to join the service group to the PN server; the PN server adds the PN device to the service group when the PN server determines that joining the service group is allowed and updates the related information of the service group, and then sends the updated related information of the service group to each PN device corresponding to a member in the service group; or

when a PN device is invited by the PN server to join the service group by initiating a request for inviting the PN device to join the service group, the method may further include:

the PN server sends a request for inviting the PN device to join the service group to the PN gateway to which the PN device belongs; the PN server adds the PN device to the service group when the PN server determines that joining the service group is allowed and updates the related information of the service group, and then sends the updated related information of the service group to each PN device corresponding to a member in the service group.

when a PN device initiates a request for leaving the service group initiatively, the method may further include:

the PN device sends the request for leaving the service group to the PN gateway to which the PN device belongs; the PN gateway sends the request for leaving the service group to the PN server; the PN server deletes the PN device from the service group and updates the related information of the service group, and then sends the updated related information of the service group to each PN device corresponding to a member in the service group; or

when a PN device is requested by another PN device to leave the service group by initiating a request for requesting the PN device to leave the service group, the method may further include:

another PN device sends the request for requesting the PN device to leave the service group to the PN gateway to which the another PN device belongs; the PN gateway sends the request for requesting the PN device to leave the service group to the PN server; the PN server deletes the PN device from the service group when the PN server determines that leaving from the service group is allowed, updates the related information of the service group, and then sends the updated related information of the service group to each PN device corresponding to a member in the service group; or

when a PN device is requested by the PN server to leave the service group by initiating a request for requesting the PN device to leave the service group, the method may further include:

the PN server sends the request for requesting the PN device to leave the service group to the PN gateway to which the PN device belongs; the PN server deletes the PN device from the service group, updates related information of the service group, and then sends the updated related information of the service group to each PN device corresponding to a member in the service group.

A system for managing a service group includes: a management unit configured to manage the service group by establishing the service group and the information table thereof and updating the service group and the information table thereof.

In the system, the information table is an information table for managing the service group, the information table includes at least one of: a name of the service group, an identifier of the service group, strategy information, member information and service type information.

In the system, when the management unit is further configured to establish the service group, a personal network (PN) server determines that the service group can be established successfully according to a response of each invited device to a request for establish the service group and related information of the service group, and establishes the information table for the service group.

In the system, when updating the service group, the management unit may further be configured to delete the service group, add a PN device to the service group, enable a PN device to leave the service group and update the information table, wherein when deleting the service group, adding the PN device to the service group and enabling the PN device to leave the service group, a caused update of the related information of the service group is achieved by updating the established information table;

wherein deleting the service group may include: the PN server determines that the service group can be deleted successfully according to a response of each PN device to a request for deleting the service group, and deletes the service group;

wherein adding the PN device to the service group may include: the PN server receives a request of the PN device for joining the service group, determines that joining the service group is allowed, and then adds the PN device to the service group and updates the related information of the service group;

wherein enabling the PN device to leave the service group may include: the PN server receives a request for enabling the PN device to leave the service group, deletes the PN device from the service group and updates the related information of the service group.

By establishing and updating a service group and the information table thereof, the disclosure achieves the management of the service group.

Due to the disclosure, convenient and effective management can be performed on a service group consisting of a great number of PN devices including the establishing of a service group and the information table thereof, and the update on the service group and the information table thereof.

### BRIEF DESCRIPTION OF THE DRAWINGS

FIG. 1 is a schematic diagram illustrating the network construction between the devices in a PN in the prior art;

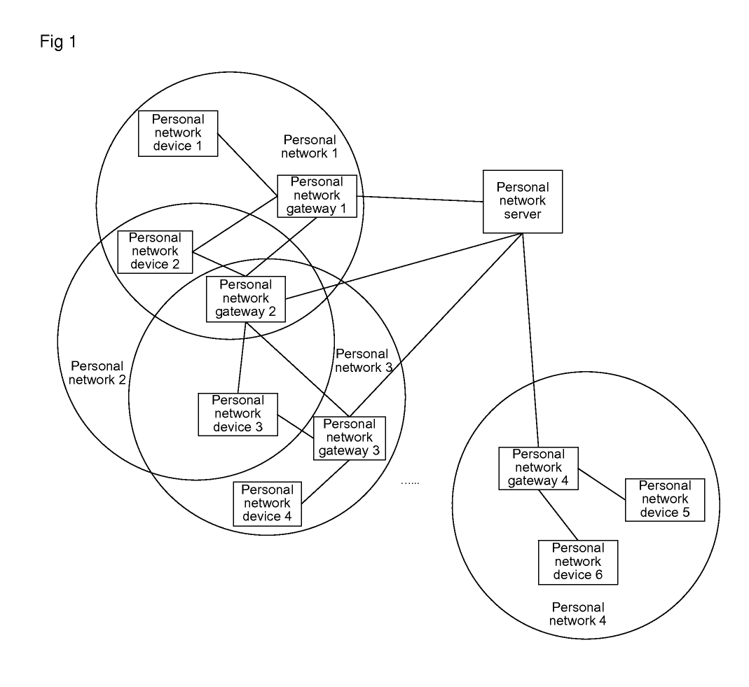

FIG. 2 is a schematic diagram illustrating the establishing of a service group in the disclosure;

FIG. 3 is a schematic diagram illustrating the establishing of a service group included before a4 shown in FIG. 2;

FIG. 4 is another schematic diagram illustrating the establishing of a service group in the disclosure;

FIG. 5 is a schematic diagram illustrating the deletion of a service group in the disclosure;

FIG. 6 is a schematic diagram illustrating the acquisition of service group information in the disclosure;

FIG. 7 is another schematic diagram illustrating the deletion of a service group in the disclosure;

FIG. 8 is a schematic diagram illustrating the addition of a device to a service group in the disclosure;

FIG. 9 is another schematic diagram illustrating the addition of a device to a service group in the disclosure;

FIG. 10 is still another schematic diagram illustrating the addition of a device to a service group in the disclosure;

FIG. 11 is a schematic diagram illustrating the leaving of a device from a service group in the disclosure;

FIG. 12 is another schematic diagram illustrating the leaving of a device from a service group in the disclosure;

FIG. 13 is still another schematic diagram illustrating the leaving of a device from a service group in the disclosure.

### DETAILED DESCRIPTION OF THE EMBODIMENTS

The basic idea of the disclosure lies in that a service group is managed by establishing and updating a service group and the information table thereof.

The implementation of the technical scheme of the disclosure is described below in detail with reference to accompanying drawings.

A method for managing a service group mainly includes the following processes:

1. The establishing of a service group, which includes the following two cases:

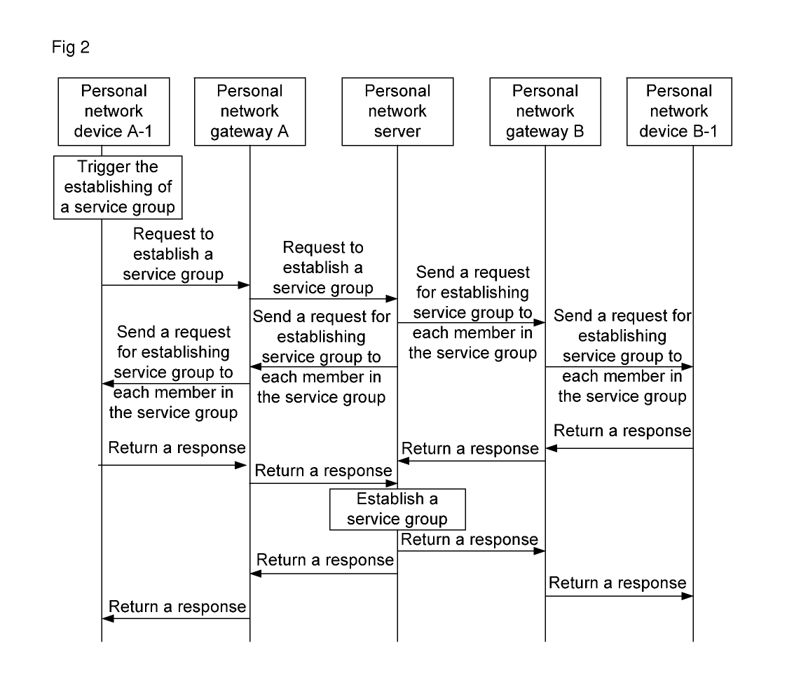

Case 1: the establishing of a service group by a PN device (including a PN gateway), as shown in FIG. 2, mainly comprises the following steps:

a1, PN device A-1 is triggered to establish a service group.

a2, PN device A-1 sends a request for establishing the service group and related information of the service group to PN gateway A to which PN device A-1 belongs, wherein

the related information of the service group may be included in the request for establishing the service group to be sent with the request for establishing the service group, or the related information of the service group is sent separately from the request for establishing the service group, without being included in the request for establishing the service group. The related information of the service group is the information used to establish the service group, and no repeated description is given here.

a3, PN gateway A sends the request for establishing the service group and the related information of the service group to a PN server.

a4, the PN server sends the request for establishing the service group and the related information of the service group to each invited member according to the received related information of the service group.

a5, the PN gateway receives the request from the PN server and then sends the received request to a corresponding PN device in the PN in which the PN gateway is located.

a6, the PN device returns a response to the PN gateway that the PN device belongs to.

a7, the PN gateway returns a response to the PN server according to the response of the PN device.

a8, the PN server determines whether or not the service group is successfully established according to the response from each invited PN device, returns a response to each PN device in the service group, and establishes a corresponding service group when the service group is successfully established.

a9, the PN gateway returns, according to the response received from the PN server, a response to a corresponding PN device in the PN in which the PN gateway is located.

Here, in the Step a1 above, there may be many triggering conditions, such as a user, a server or a request from a third party.

Here, in the Step a2 above, the related information of the service group includes member information, strategy information and service type information.

Here, in the Steps a2 and a3 above, the related information of the service group may be sent separately from the request for establishing the service group, and this situation will be described later in detail.

Here, in the Step a8, how to determine by the PN server whether or not the service group is successfully established according to the response of each PN device may be based on the actual situation, for example, different configurations may be used according to the type of the service group, for instance, the PN server determines the service group is successfully established when all PN devices, or at least one PN device, agree/agrees to the establishing, or no matter whether or not there is a PN device agreeing to the establishing. For the last case, the determination process described in Step a8 may be omitted, and the PN server can establish the service group directly.

The different configurations based on the actual situation are correlated to the related information of the service group, specifically, to the strategy information and/or service type information. No related repeated description is given here.

Here, in the Step a8, establishing a corresponding service group includes establishing an information table for managing the service group, wherein the name or identifier of the service group, the related strategy of the service group and a list of the members or device in the service group may be contained in the information table.

Here, the change (or referred to as update) in the information of the service group caused by the subsequent deletion of the service group, the addition of a device to the service group, the leaving of a device from the service group is implemented by changing the information in the information table. It should be noted here that this scheme further includes updating the information table, besides deleting the service group, adding a device to the service group and enabling a device to leave the service group when updating the service group. For instance, the information table is updated due to that the strategy of the service group is updated by a user or a system, although no device is added or leaves.

Here, the information contained in the response returned in the Step a9 may contain the related information of the successfully established service group.

Here, if the establishing of the service group is initiated by PN gateway A, then the first two steps in the Steps a1-a9 are omitted.

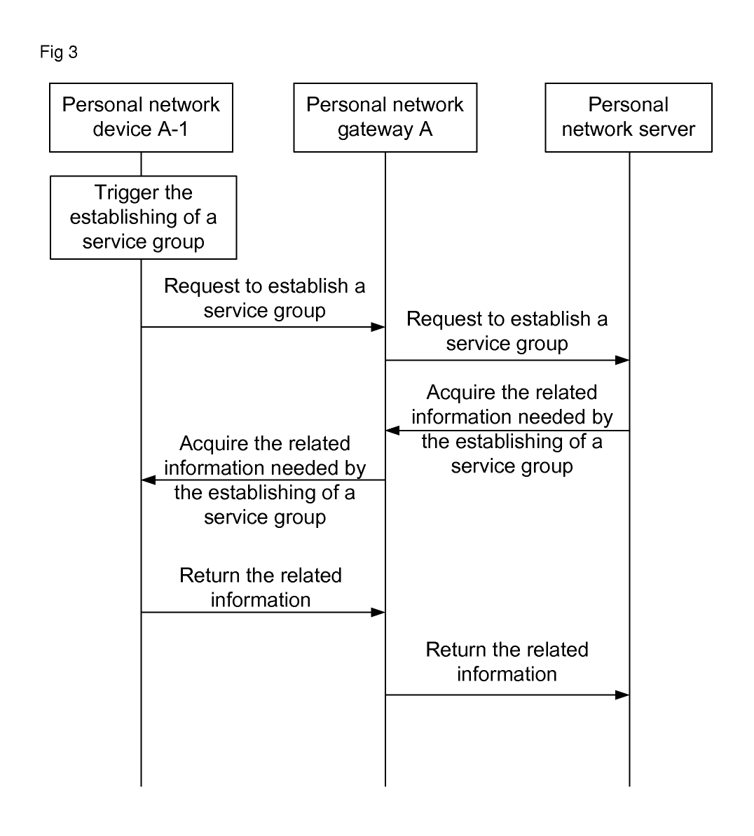

Here, as shown in FIG. 3, the following other processes may be included before the a4:

x1, a PN device A-1 is triggered to establish a service group.

x2, PN device A-1 sends a request for establishing the service group to PN gateway A to which PN device A-1 belongs.

x3, PN gateway A sends the request for establishing the service group to a PN server.

x4, the PN server returns a response to PN gateway A to request to acquire the related information of the service needed by the establishing the service group.

x5, PN gateway A returns a response to PN device A-1 to request to acquire the related information of the service needed by the establishing the service group.

x6, PN device A-1 returns the related information of the service group to PN gateway A.

x7, PN gateway A returns the related information of the service group to the PN server.

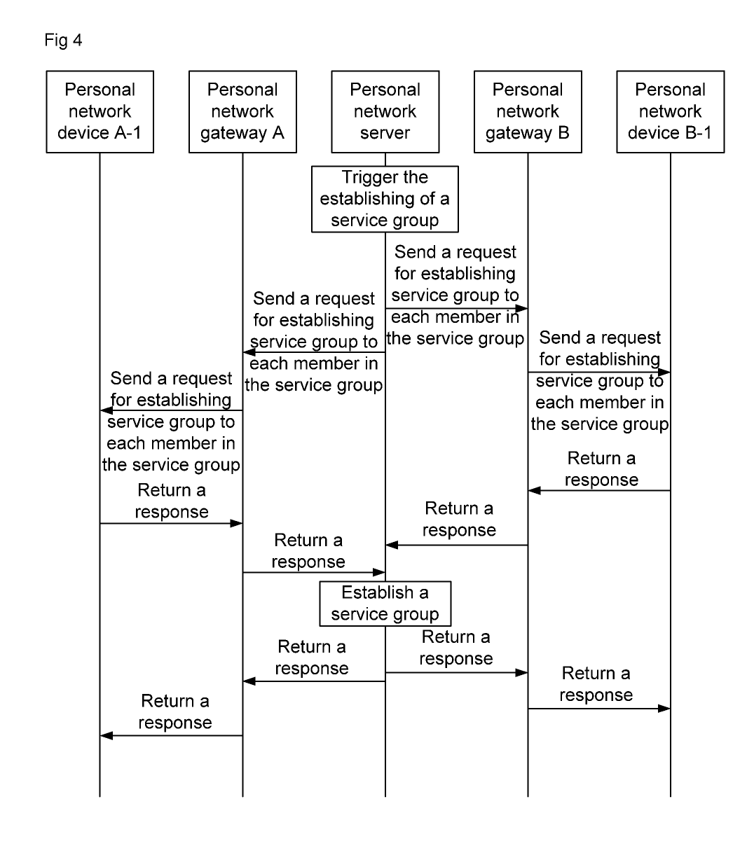

Case 2: the establishing of a service group by a PN server, as shown in FIG. 4, mainly comprises the following steps:

b1, the PN server is triggered to establish a service group.

b2, the PN server sends a request for establishing the service group and related information of the service group to each member in the service group.

b3, a PN gateway receives the request from the PN server and then sends the received request to a corresponding PN device in the PN in which the PN gateway is located.

b4, the PN device returns a response to the PN gateway to which PN device belongs.

b5, the PN gateway returns a response to the PN server according to the response of the PN device.

b6, the PN server determines whether or not the service group is successfully established according to the response of each PN device, returns a response to each PN device in the service group, and establishes a corresponding service group if the service group is successfully established.

b7, the PN gateway returns, according to the response received from the PN server, a response to a corresponding PN device in the PN in which the PN gateway is located.

Here, in the Step b1 above, there may be many triggering conditions, such as an operator or a request from a third party.

Here, in the Step b2 above, the related information of the service group includes member information, strategy information and service type information.

Here, in the Step b6 above, how to determine by the PN server whether or not the service group is successfully established according to the response of each PN device may be based on actual situation, for example, different configurations may be used according to the type of the service group, for instance, the PN server determines the service group is successfully established when all PN devices, or at least one PN device agree/agrees to the establishing, or no matter whether there is a PN device agreeing to the establishing.

Here, in the Step b6 above, establishing a corresponding service group includes assigning a name and storing related information for the service group.

Here, the information contained in the response returned in the Step b7 may contain the related information of the successfully established service group.

2. The deletion of a service group, which includes the following two cases:

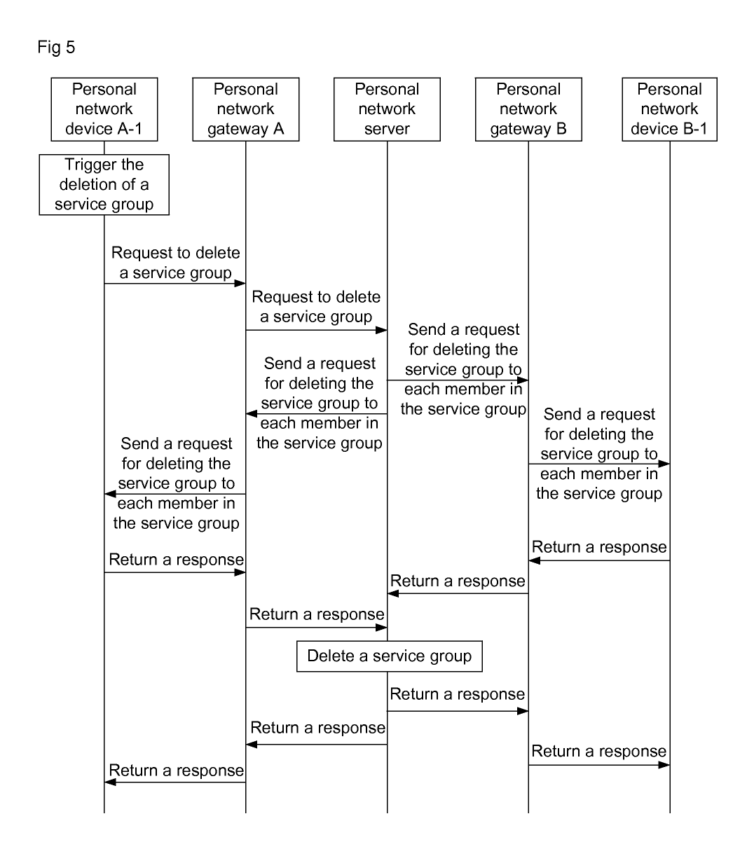

Case 1: the deletion of a service group initiated by a PN device (including PN gateway), as shown in FIG. 5, mainly comprises the following steps:

c1, PN device A-1 is triggered to delete a service group.

c2, PN device A-1 sends a request for deleting the service group to PN gateway A to which PN device A-1 belongs.

c3, PN gateway A sends the request for deleting the service group to a PN server.

c4, the PN server sends the request for deleting the service group to each member in the service group according to the received request.

c5, a PN gateway receives the request from the PN server and then sends the received request to a corresponding PN device in the PN in which the PN gateway is located.

c6, the PN device returns a response to the PN gateway to which the PN device belongs.

c7, the PN gateway returns a response to the PN server according to the response of the PN device.

c8, the PN server determines whether or not the service group is successfully deleted according to the response of each PN device, returns a response to each PN device in the service group, and deletes a corresponding service group when the service group is successfully deleted.

c9, the PN gateway returns, according to the response received from the PN server, a response to a corresponding PN device in the PN in which the PN gateway is located.

Here, in the Step c1 above, there may be many triggering conditions, such as a user, server or a third party request.

Here, in the Step c2 above, the identifier of the deleted service group should be provided.

Here, before the Step c2 above, the PN device may need to acquire the information of an available service group, and this situation will be described later in detail.

Here, in the Step c4 above, the sending of the request for deleting the service group to the device initiating the request can be omitted if the device is contained in the service group.

Here, in the Step c8 above, how to determine by the PN server whether or not the service group is successfully deleted according to the response of each PN device may be based on the actual situation, for example, different configurations may be used according to the type of the service group, for instance, the PN server determines the service group is deleted only if all PN devices agree to the deletion or the PN server deletes the service group forcedly. In the case of a forced deletion, the Steps c4-c9 above can be omitted, that is, in the case of a forced deletion, the confirmation by each device is unnecessary, the service group can be deleted directly, and a notification is sent to the members in the service group.

Here, if the deletion of a service group is initiated by PN gateway A, the first two steps in the Steps c1-c9 are omitted.

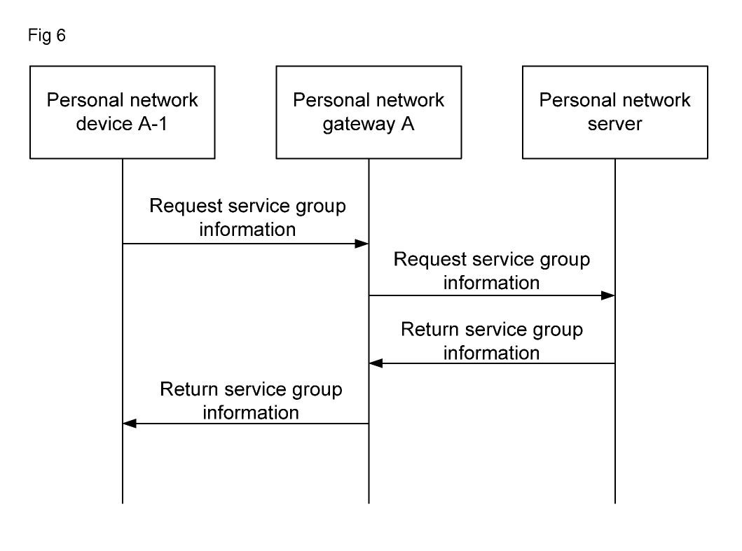

Here, as shown in FIG. 6, the service group information acquisition that may be included before the Step c2 includes the following steps:

y1, PN device A-1 sends a service group information acquisition request to a PN gateway A.

y2, PN gateway A sends the service group information acquisition request to a PN server.

y3, the PN server returns the information of the service group to PN gateway A.

y4, PN gateway A returns the information of the service group to PN device A-1.

Here, in the Steps y1-y4 above, if the information of the service group is stored in PN gateway A, then the information of the service group can be directly returned to PN device A-1, without being requested from the PN server.

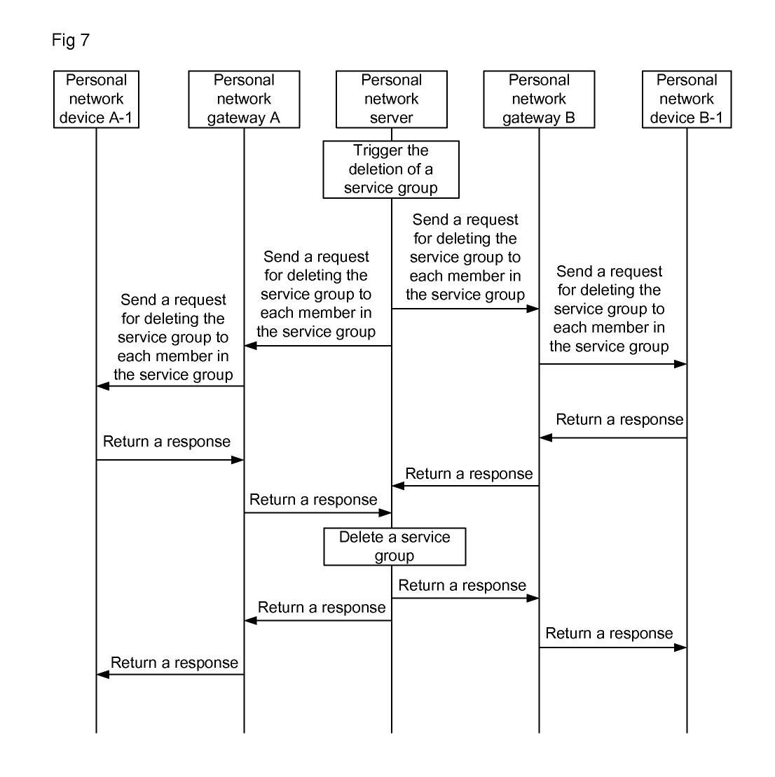

Case 2: the deletion of a service group is initiated by a PN server, as shown in FIG. 7, mainly comprises the following steps:

d1, the PN server is triggered to delete a service group.

d2, the PN server sends a request for deleting the service group to each member in the service group.

d3, a PN gateway receives the request from the PN server and then sends the received request to a corresponding PN device in the PN in which the PN gateway is located.

d4, the PN device returns a response to the PN gateway to which PN device belongs.

d5, the PN gateway returns a response to the PN server according to the response of the PN device.

d6, the PN server determines whether or not the service group is successfully deleted according to the response of each PN device, returns a response to each PN device in the service group, and deletes a corresponding service group when it determines the service group is successfully deleted.

d7, the PN gateway, according to the response received from the PN server, a corresponding PN device in the PN in which the PN gateway is located.

Here, in the Step d1 above, there may be many triggering conditions, such as an operator or a third party request.

Here, in the Step d6 above, how to determine by the PN server whether or not the service group is successfully deleted according to the response of each PN device may be based on the actual situation, for example, different configurations may be used according to the type of the service group, for instance, the PN server determines the service group is deleted only if all PN devices agree to the deletion, or the PN server deletes the service group forcedly. In the case of a forced deletion, the Steps d2-d7 above can be omitted, that is, in the case of a forced deletion, the confirmation by each device is unnecessary, the service group can be deleted directly, and a notification is sent to the members in the service group.

3. The addition of a device to a service group, which includes the following three cases:

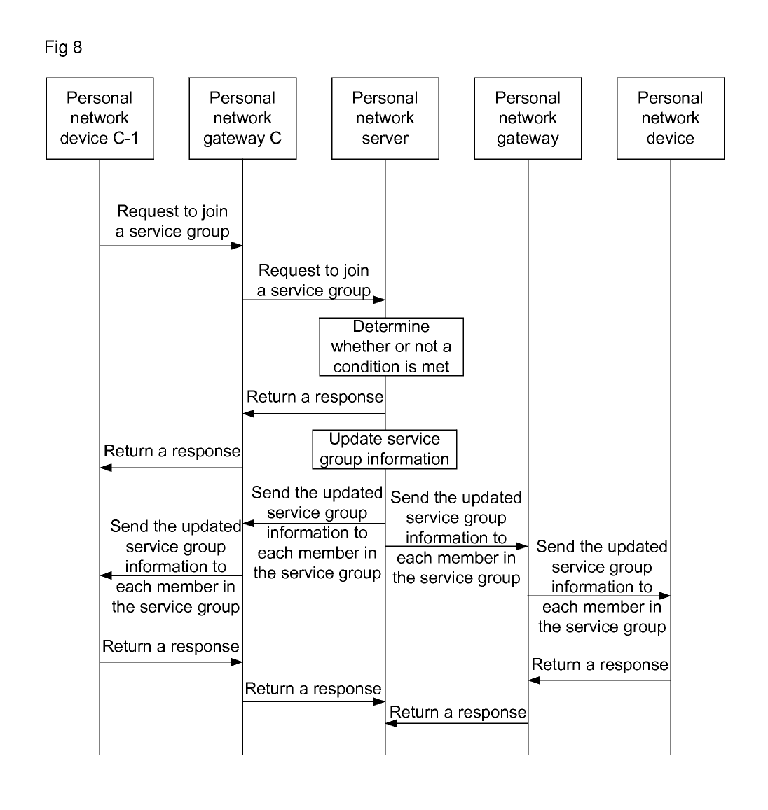

Case 1: a device initiatively requests to join a service group, as shown in FIG. 8, the joining of a device to a service group mainly includes the following steps:

e1, PN device C-1 requests to join a service group.

e2, PN gateway C sends the request to a PN server.

e3, the PN server determines whether or not the device meets a service group joining condition.

e4, the PN server returns a response to PN gateway C according to the result of the determination.

e5, PN gateway C sends the response to PN device C-1.

e6, the PN server updates the information of the service group if the device joins the service group.

e7, the PN server sends the updated information of the service group to each member in the service group.

e8, a PN gateway receives the information and then sends the received information to a PN device.

e9, the PN device returns a response to a PN gateway.

e10, the PN device returns a response to the PN server.

Here, before the Step el above, PN device C-1 may need to acquire a list of existing service groups.

Here, in the Steps e4 and e5 above, if the latest service group information is already returned to PN device C-1, then it is unnecessary in the Steps e7-e10 to send the latest service group information to PN device C-1.

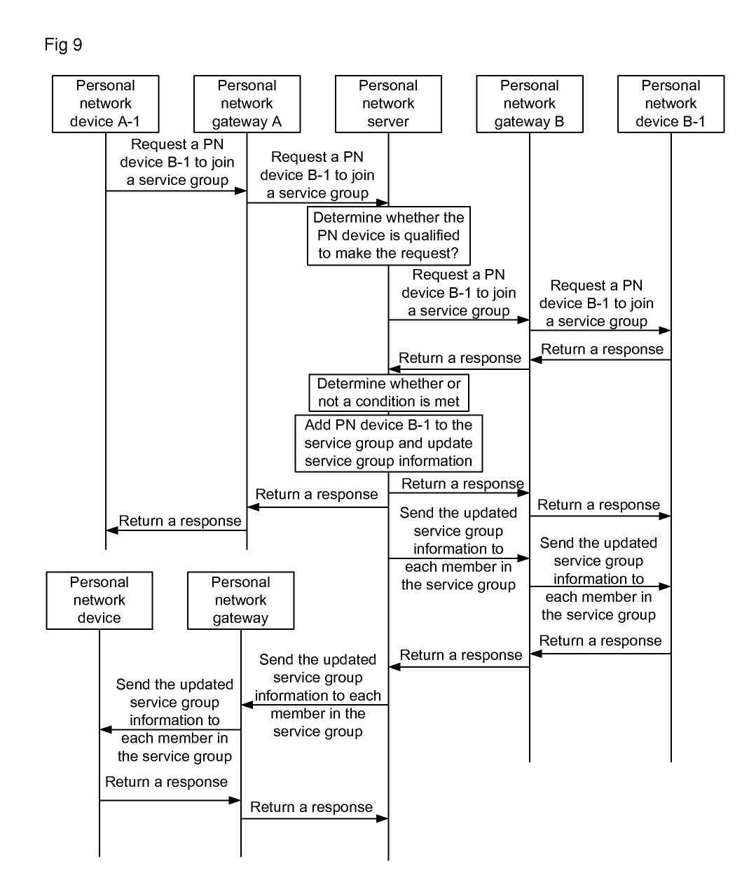

Case 2: a device is invited by another device, which refers to a PN device (including a PN gateway), to join a service group, as shown in FIG. 9, the joining of the device to a service group mainly includes the following steps:

f1, PN device A-1 invites PN device B-1 to join a service group.

f2, PN gateway A sends the request of PN device A-1 to a PN server.

f3, the PN server determines whether or not PN device A-1 is qualified to request PN device B-1 to join the service group.

f4, the PN server sends the request to PN gateway B.

f5, PN gateway B sends the request to PN device B-1.

f6, PN device B-1 returns a response to PN gateway B.

f7, PN gateway B returns a response to the PN server.

f8, the PN server determines whether or not PN device B-1 meets a service group joining condition.

f9, the device meeting the condition joins the service group, and then the information of the service group is updated.

f10, the PN server returns a response to PN gateways A and B.

f11, the PN gateways A and B respectively return a response to PN devices A-1 and B-1.

f12, if the information of the service group is updated, then the PN server sends the updated information of the service group to each member in the service group.

f13, a PN gateway receives the updated information of the service group and then forwards the received information to a PN device.

f14, the PN device returns a response to a PN gateway.

f15, the PN gateway returns a response to the PN server.

Here, in the Steps f1-f15 above, PN device A-1 may belong to the service group or not, and in the latter case, the transmission of the updated information of the service group to PN device A-1 is unnecessary.

The Step f3 above is optional here.

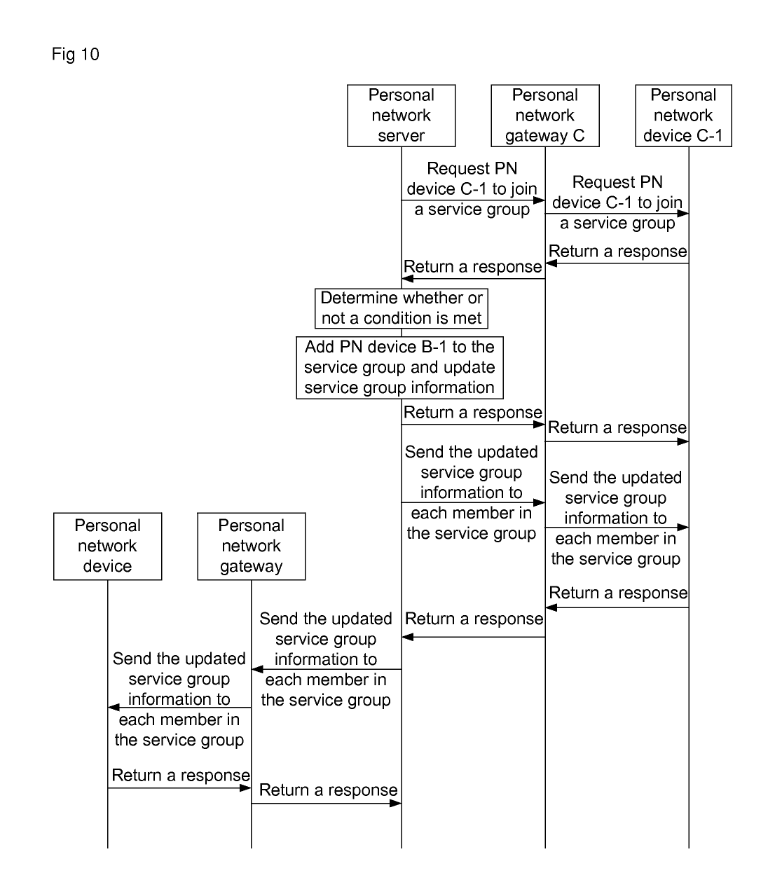

Case 3: a device is invited by another device, which refers to a PN server, to join a service group, as shown in FIG. 10, the joining of the device to a service group mainly comprises the following steps:

g1, the PN server invites a PN device C-1 to join a service group.

g2, a PN gateway C sends the request to PN device C-1.

g3, PN device C-1 returns a response to PN gateway C.

g4, PN gateway C returns a response to the PN server.

g5, the PN server determines whether or not PN device C-1 meets a service group joining condition.

g6, the device meeting the condition joins the service group, and then the information of the service group is updated.

g7, the PN server returns a response to PN gateway C.

g8, PN gateway C returns a response to PN device C-1.

g9, if the information of the service group is updated, then the PN server sends the updated information of the service group to each member in the service group.

g10, a PN gateway receives the updated information of the service group and then forwards the received information to a PN device.

g11, the PN device returns a response to a PN gateway.

g12, the PN gateway returns a response to the PN server.

4. The leaving of a device from a service group includes the following three cases:

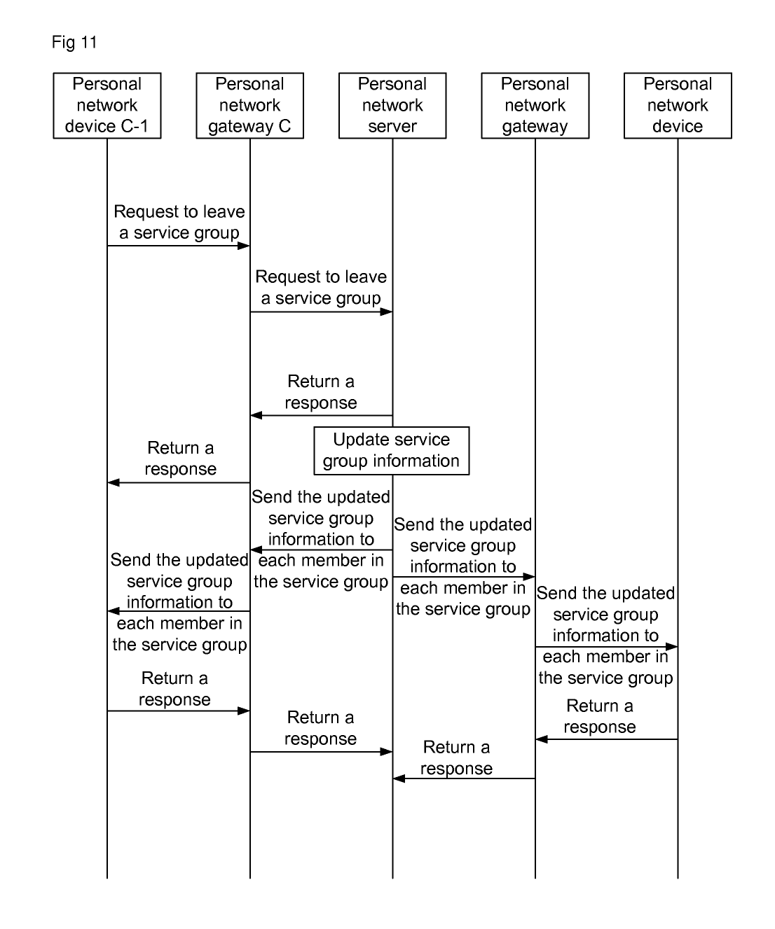

Case 1: a device initiatively requests to leave a service group, as shown in FIG. 11, the leaving of a device from a service group mainly includes the following steps:

h1, a PN device C-1 requests to leave a service group.

h2, a PN gateway C sends the request to a PN server.

h3, the PN server returns a response to PN gateway C.

h4, PN gateway C returns the response to PN device C-1.

h5, the PN server deletes the device from the service group and updates the information of the service group.

h6, the PN server sends the updated information of the service group to each member in the service group.

h7, a PN gateway receives the information and then sends the received information to a PN device.

h8, the PN device returns a response to a PN gateway.

h9, the PN gateway returns a response to the PN server.

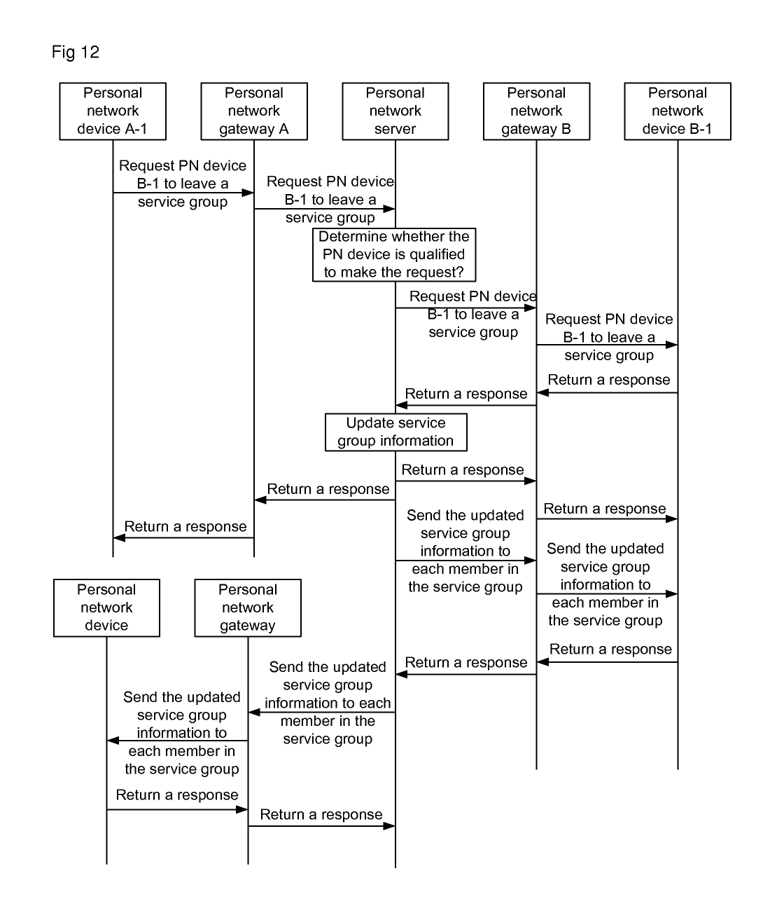

Case 2: a device is requested by another device, which refers to a PN device (including a PN gateway), to leave a service group, as shown in FIG. 12, the leaving of a device from a service group mainly includes the following steps:

i1, PN device A-1 requests PN device B-1 to leave a service group.

i2, PN gateway A sends the request of PN device A-1 to a PN server.

i3, the PN server determines whether or not PN device A-1 is qualified to request PN device B-1 to leave the service group.

i4, the PN server sends the request to a PN gateway B.

i5, PN gateway B sends the request to PN device B-1.

i6, PN device B-1 returns a response to PN gateway B.

i7, PN gateway B returns a response to the PN server.

i8, the PN server deletes the device from the service group and updates the information of the service group.

i9, the PN server returns a response to PN gateways A and B.

i10, PN gateways A and B respectively return a response to PN devices A-1 and B-1.

i11, if the information of the service group is updated, then the PN server sends the updated information of the service group to each member in the service group.

i12, a PN gateway receives the updated information of the service group and then forwards the received information to a PN device.

i13. the PN device returns a response to a PN gateway.

i14, the PN gateway returns a response to the PN server.

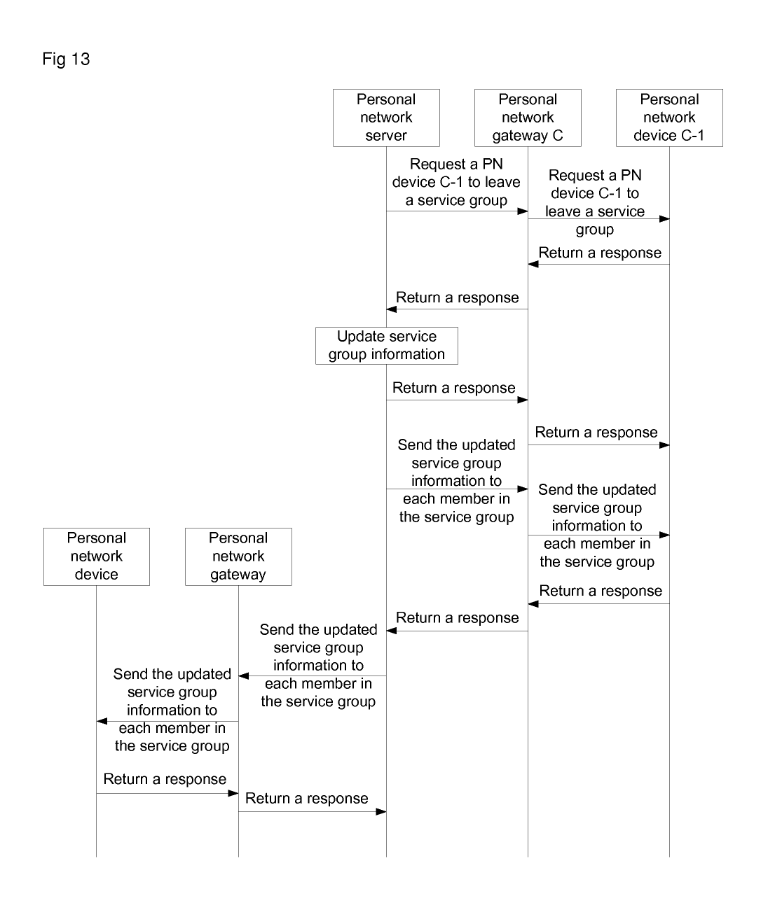

Case 3: a device is requested by another device, which refers to a PN server, to leave a service group, as shown in FIG. 13, the leaving of a device from a service group mainly comprises the following steps:

j1, the PN server notifies a PN device C-1 to leave a service group.

j2, a PN gateway C sends the request to PN device C-1.

j3, PN device C-1 returns a response to PN gateway C.

j4, PN gateway C returns a response to the PN server.

j5, the PN server deletes the device from the service group and updates the information of the service group.

j6, the PN server returns a response to PN gateway C.

j7, PN gateway C returns a response to PN device C-1.

j8, if the information of the service group is updated, then the PN server sends the updated information of the service group to each member in the service group.

j9, a PN gateway receives the updated information of the service group and then forwards the received information to a PN device.

j10, the PN device returns a response to a PN gateway.

j11, the PN gateway returns a response to the PN server.

The disclosure is exemplarily illustrated below, mainly aiming at the information update in a service group; when the information in a service group information table is updated, it is necessary to inform the member in the service group of the update, and any off-line member is informed when it is online again. The information in the information table of a service group may be updated when a service group is established, deleted, or there is a change in the members of a service group, the name of a service group or the strategy of the service group.

### APPLICATION EXAMPLE 1

There is a handset (PN gateway) and an MP4 (PN device) in the PNs of user A and user B. The MP4 of user A invites the MP4 of user B to establish a service group together. The establishing flow of the service group includes the following steps:

Step 101: the MP4 of user A sends a request for establishing the service group and the related information of a service group to the handset of user A, wherein the related information of the service group contains the name of the service group: SG_001, the strategy of the service group: free game, and the members of the service group: MP4A and MP4B.

Step 102: the handset of user A sends the request for establishing the service group and the related information of the service group to a PN server.

Step 103: the PN server sends the request for establishing the service group and the related information of the service group to the MP4 of user B according to the received related information of the service group.

Step 104: the handset of user B receives the request from the PN server and then sends the received request to the MP4 of user B.

Step 105: the MP4 of user B returns a response to the handset of user B to agree to establish the service group.

Step 106: the handset of user B returns a response to the PN server according to the response of the MP4 of user B.

Step 107: the PN server determines that the service group is successfully established according to the response of each PN device, returns a response to each PN device in the service group, and establishes a corresponding service group and a corresponding information table, wherein the information table contains the name of the service group: SG_001, the strategy of the service group: free game, and the members of the service group: MP4A and MP4B.

Step 108: the handsets of users A and B return a response to the MP4s of users A and B according to the responses received from the PN server.

### APPLICATION EXAMPLE 2

There is a handset (PN gateway) and an MP4 (PN device) in the PNs of user A, user B and user C, wherein the MP4s of users A and B have formed a service group with an identifier ‘SG_001’. The joining of the device to the service group includes the following steps:

Step 201: the MP4 of user C requests to join the service group SG_001.

Step 202: the handset of user C sends the request to a PN server.

Step 203: the PN server determines whether or not the device meets a service group joining condition.

Step 204: the PN server returns a response to the handset of user C according to the result of the determination to agree to the joining.

Step 205: the handset of user C returns the response to the MP4 of user C.

Step 206: the PN server updates the information table of the service group.

Step 207: the PN server sends the updated information of the service group to each member in the service group.

Step 208: the handsets of users A, B and C receive the information and then send the received information to corresponding MP4s.

Step 209: the MP4s return a response to corresponding handsets.

Step 210: each handset returns a response to the PN server.

### APPLICATION EXAMPLE 3

There is a handset (PN gateway) and an MP4 (PN device) in the PNs of user A, user B, and user C, wherein the MP4s of users A, B, and C have formed a service group with an identifier ‘SG_001’. The leaving of the device from the service group includes the following steps:

Step 301: a PN server notifies the MP4 of user C to leave the service group SG_001.

Step 302: the handset of user C sends the request to the MP4 of user C.

Step 303: the MP4 of user C returns a response to the handset of user C to agree to the leaving.

Step 304: the handset of user C returns a response to the PN server.

Step 305: the PN server deletes the device from the service group and updates the information of the service group.

Step 306: the PN server returns a response to the handset of user C.

Step 307: the handset of user C returns a response to the MP4 of user C.

Step 308: the PN server sends the updated information of the service group to each member in the service group.

Step 309: the handsets of users A and B receive the updated information of the service group and then send the received information to the MP4s of users A and B.

Step 310: the MP4s return a response to corresponding handsets.

Step 311: the handsets of users A and B respectively return a response to the PN server.

### APPLICATION EXAMPLE 4

There is a handset (PN gateway) and an MP4 (PN device) in the PNs of user A and user B, wherein the MP4s of users A and B have formed a service group with an identifier ‘SG_001’. The deletion of the service group includes the following steps:

Step 401: a PN server sends a request for deleting the service group to each member in the service group SG_001.

Step 402: the handsets of users A and B receive the request from the PN server and then send the received request to corresponding MP4s.

Step 403: the MP4s return a response to corresponding handsets to agree to the deletion.

Step 404: the handsets of users A and B return a response to the PN server according to the responses of the MP4s.

Step 405: the PN server determines that the service group is successfully deleted according to the responses of the MP4s of users A and B, returns a response to each PN device in the service group, and deletes a corresponding service group.

Step 406: the handsets of users A and B return a response to the MP4s of users A and B according to the responses received from the PN server.

A system for managing a service group comprises: a management unit configured to manage the service group by establishing the service group and the information table thereof and updating the service group and the information table thereof.

Here, the information table, which is an information table for managing the service group, includes at least one of: a name of the service group, an identifier of the service group, the strategy information of the service group, the member information of the service group and service type information.

In the system, when the management unit is further configured to establish the service group, a personal network (PN) server determines that the service group can be established successfully according to a response of each device to a request for establish the service group and related information of the service group, and establishes the information table for the service group.

In the system, when updating the service group, the management unit is further configured to delete the service group, add a PN device to the service group, enable a PN device to leave the service group and update the information table, wherein when deleting the service group, adding the PN device to the service group and enabling the PN device to leave the service group, a caused update of the related information of the service group is achieved by updating the established information table, wherein

Wherein the deletion of the service group includes: the PN server determines that a service group can be deleted successfully according to a response of each PN device to a request for deleting the service group, and deletes the service group;

Wherein the addition of the PN device to the service group includes: the PN server receives a request of the PN device for joining the service group, determines that joining the device to the service group is allowed, and then adds the PN device to the service group and updates the related information of the service group;

wherein enabling the PN device to leave the service group includes : the PN server receives a request for enabling the PN device to leave the service group, deletes the PN device from the service group and updates the related information of the service group.

The aforementioned is merely the preferred embodiments of the disclosure but shall not limit to the protection scope of the disclosure.

1. A method for managing a service group, comprising: managing the service group by establishing the service group and an information table thereof and updating the service group and the information table thereof.

2. The method according to claim 1, wherein the information table is an information table for managing the service group; and
the information table comprises at least one of: a name of the service group, an identifier of the service group, strategy information, member information and service type information.

3. The method according to claim 1, wherein establishing the service group comprises: establishing, by a personal network (PN) server, the service group directly according to a request for establishing the service group, and sending an invitation to each invited PN device when there are invited PN devices that are invited to join the service group;
wherein when establishing the service group, the method further comprises:
establishing the information table for the service group.

4. The method according to claim 1, wherein establishing the service group comprises: determining, by the PN server, that the service group can be established successfully according to a response of each invited PN device to the request for establishing the service group and related information of the service group, and establishing the service group; and
wherein when establishing the service group, the method further comprises: establishing the information table for the service group;
when updating the service group, the method further comprises: deleting the service group, adding a PN device to the service group, enabling a PN device to leave the service group and updating the information table; wherein when deleting the service group, adding the PN device to the service group and enabling the PN device to leave the service group, a caused update of the related information of the service group is achieved by updating the established information table;
wherein deleting the service group comprises: determining, by the PN server, that the service group can be deleted successfully according to a response of each PN device to a request for deleting the service group, and deleting the service group;
wherein adding the PN device to the service group comprises: receiving, by the PN server, a request of the PN device for joining the service group, determining that joining the service group is allowed, and then adding the PN device to the service group and updating the related information of the service group; and
wherein enabling the PN device to leave the service group comprises: receiving, by the PN server, a request for enabling the PN device to leave the service group, deleting the PN device from the service group and updating the related information of the service group.

5. The method according to claim 4, wherein the method further comprises: when a PN gateway is triggered to initiate the request for establishing the service group, sending, by the PN gateway, the request for establishing the service group and the related information of the service group to the PN server;
sending, by the PN server, the request for establishing the service group and the related information of the service group to each PN device corresponding to a member in the service group; and
establishing, by the PN server, the service group when the PN server determines that the service group can be established successfully according to the response returned from each PN device; or
the method further comprises: when the PN device is triggered to initiate the request for establishing the service group, sending, by the PN device, the request for establishing the service group and the related information of the service group to the PN gateway to which the PN device belongs;
sending, by the PN gateway, the request for establishing the service group and the related information of the service group to the PN server;
sending, by the PN server, the request for establishing the service group and the related information of the service group to each PN device corresponding to a member in the service group; and
establishing, by the PN server, the service group when the PN server determines that the service group can be established successfully according to the response returned from each PN device; or
the method further comprises: when the PN server is triggered to initiate the request for establishing the service group, sending, by the PN server, the request for establishing the service group and the related information of the service group to each PN device corresponding to a member in the service group; and
establishing, by the PN server, the service group when the PN server determines that the service group can be established successfully according to the response returned from each PN device.

6. The method according to claim 5, wherein the method further comprises: sending the related information of the service group by including it in the request for establishing the service group or sending the related information of the service group and the request for establishing the service group separately when the PN gateway or the PN device is triggered to send the request for establishing the service group and the related information of the service group.

7. The method according to claim 4, wherein the method further comprises: when a PN gateway is triggered to initiate the request for deleting the service group, sending, by the PN gateway, the request for deleting the service group to the PN server; sending, by the PN server, the request for deleting the service group to each PN device corresponding to a member in the service group; and deleting, by the PN server, the service group when the PN server determines that the service group can be deleted successfully according to the response returned from each PN device; or the method further comprises: when the PN device is triggered to initiate the request for deleting the service group, sending, by the PN device, the request for deleting the service group to the PN gateway to which the PN device belongs; sending, by the PN gateway, the request for deleting the service group to the PN server;
sending, by the PN server, the request for deleting the service group to each PN device corresponding to a member in the service group; and deleting, by the PN server, the service group when the PN server determines that the service group can be deleted successfully according to the response returned from each PN device; or
the method further comprises: when the PN server is triggered to initiate the request for deleting the service group, sending, by the PN server, the request for deleting the service group to each PN device corresponding to a member in the service group; and deleting, by the PN server, the service group when the PN server determines that the service group can be deleted successfully according to the response returned from each PN device.

8. The method according to claim 7, wherein the method further comprises: when the PN gateway or the PN device is triggered, and before the request for deleting the service group is sent, requesting the related information of the service group from the PN server;
the method further comprises: when the PN gateway or the PN device is triggered, and when sending the request for deleting the service group, carrying an identifier of the service group to be deleted in the request for deleting the service group.

9. The method according to claim 4, wherein the method further comprises: when a PN device initiates a request for joining the service group initiatively, sending, by the PN device, the request for joining the service group to a PN gateway to which the PN device belongs; sending, by the PN gateway, the request for joining the service group to the PN server; adding, by the PN server, the PN device to the service group when the PN server determines that joining the service group is allowed, updating the related information of the service group, and sending the updated related information of the service group to each PN device corresponding to a member in the service group; or
the method further comprises: when a PN device is invited by another PN device to join the service group by initiating a request for inviting the PN device to join the service group, sending, by the another PN device, the request for inviting the PN device to join the service group to the PN gateway to which the another PN device belongs; sending, by the PN gateway, the request for inviting the PN device to join the service group to the PN server; adding, by the PN server, the PN device to the service group when the PN server determines that joining the service group is allowed and updating the related information of the service group, and sending the updated related information of the service group to each PN device corresponding to a member in the service group; or
the method further comprises: when a PN device is invited by the PN server to join the service group by initiating a request for inviting the PN device to join the service group, sending, by the PN server, a request for inviting the PN device to join the service group to the PN gateway to which the PN device belongs; adding, by the PN server, the PN device to the service group when the PN server determines that joining the service group is allowed and updating the related information of the service group, and sending the updated related information of the service group to each PN device corresponding to a member in the service group.

10. The method according to claim 4, wherein the method further comprises: when a PN device initiates a request for leaving the service group initiatively, sending, by the PN device, the request for leaving the service group to the PN gateway to which the PN device belongs; sending, by the PN gateway, the request for leaving the service group to the PN server; deleting, by the PN server, the PN device from the service group and updating the related information of the service group, and sending the updated related information of the service group to each PN device corresponding to a member in the service group; or
the method further comprises: when a PN device is requested by another PN device to leave the service group by initiating a request for requesting the PN device to leave the service group, sending, by the another PN device, the request for requesting the PN device to leave the service group to the PN gateway to which the another PN device belongs; sending, by the PN gateway, the request for requesting the PN device to leave the service group to the PN server; deleting, by the PN server, the PN device from the service group when the PN server determines that leaving from the service group is allowed and updating the related information of the service group, and sending the updated related information of the service group to each PN device corresponding to a member in the service group; or
the method further comprises: when a PN device is requested by the PN server to leave the service group by initiating a request for requesting the PN device to leave the service group, sending, by the PN server, the request for requesting the PN device to leave the service group to the PN gateway to which the PN device belongs; deleting, by the PN server, the PN device from the service group and updating the related information of the service group, and sending the updated related information of the service group to each PN device corresponding to a member in the service group.

11. A system for managing a service group, comprising: a management unit configured to manage the service group by establishing the service group and the information table thereof and updating the service group and the information table thereof.

12. The system according to claim 11, wherein the information table is an information table for managing the service group; and
the information table comprises at least one of: a name of the service group, an identifier of the service group, strategy information, member information and service type information.

13. The system according to claim 11, wherein when the management unit is further configured to establish the service group, a personal network (PN) server determines that the service group can be established successfully according to a response of each invited device to a request for establish the service group and related information of the service group, and establishes the information table for the service group.

14. The system according to claim 13, wherein when updating the service group, the management unit is further configured to delete the service group, add a PN device to the service group, enable a PN device to leave the service group and update the information table;
wherein when deleting the service group, adding the PN device to the service group and enabling the PN device to leave the service group, a caused update of the related information of the service group is achieved by updating the established information table;
wherein deleting the service group comprises: the PN server determines that the service group can be deleted successfully according to a response of each PN device to a request for deleting the service group, and deletes the service group;
wherein adding the PN device to the service group comprises: the PN server receives a request of the PN device for joining the service group, determines that joining the service group is allowed, and then adds the PN device to the service group and updates the related information of the service group; and
wherein enabling the PN device to leave the service group comprises: the PN server receives a request for enabling the PN device to leave the service group, deletes the PN device from the service group and updates the related information of the service group.

15. The system according to claim 12, wherein when the management unit is further configured to establish the service group, a personal network (PN) server determines that the service group can be established successfully according to a response of each invited device to a request for establish the service group and related information of the service group, and establishes the information table for the service group.

16. The system according to claim 15, wherein when updating the service group, the management unit is further configured to delete the service group, add a PN device to the service group, enable a PN device to leave the service group and update the information table;
wherein when deleting the service group, adding the PN device to the service group and enabling the PN device to leave the service group, a caused update of the related information of the service group is achieved by updating the established information table;
wherein deleting the service group comprises: the PN server determines that the service group can be deleted successfully according to a response of each PN device to a request for deleting the service group, and deletes the service group;
wherein adding the PN device to the service group comprises: the PN server receives a request of the PN device for joining the service group, determines that joining the service group is allowed, and then adds the PN device to the service group and updates the related information of the service group; and
wherein enabling the PN device to leave the service group comprises: the PN server receives a request for enabling the PN device to leave the service group, deletes the PN device from the service group and updates the related information of the service group.
